(19) United States
(12) Patent Application Publication
(10) Pub. No.: US 2025/0196555 A1
(43) Pub. Date: Jun. 19, 2025

(54) Over the Shock Shaft Bump Stops

(71) Applicant: Curtis Glenn, Tucson, AZ (US)

(72) Inventor: Curtis Glenn, Tucson, AZ (US)

(21) Appl. No.: 19/047,942

(22) Filed: Feb. 7, 2025

Related U.S. Application Data
(63) Continuation-in-part of application No. 18/374,505, filed on Sep. 28, 2023.
Application No. 18/374,505 is a continuation of application No. 16/853,710, filed on Apr. 20, 2020, now Pat. No. 11,827,071.
(60) Provisional application No. 62/836,574, filed on Apr. 19, 2019.

(51) Int. Cl. B60G 7/04

(52) U.S. Cl. CPC B60G 7/04; B60G 2202/143; B60G 2204/4502

(57) ABSTRACT

A bump stop system is designed for use in a vehicle suspension system featuring a shock assembly consisting of a shock shaft, shock can, and shock hat or shock eye. The system comprises a bump stop body configured to interact with the shock shaft and may include features such as grooves extending into the bump stop body, a composite structure of layered components, cast-in-place metal hardware for securing the bump stop, and a friction fit for placement. Additionally, the bump stop may be used with a coil spring, with the shock hat also functioning as a coil cup. The system may include an outer surface with a slit for fitting around the shock shaft, with hardware for closure. Methods for forming the bump stop involve processes such as pouring or injecting elastomeric mixtures, curing, and potential heating, with the option to serve as a spring assist and accommodate specific applications.

### CROSS REFERENCE TO RELATED APPLICATION

This Application is a continuation-in-part of U.S. application Ser. No. 18/374,505, filed Sep. 28, 2023, which is a continuation of U.S. application Ser. No. 16/853,710 filed Apr. 20, 2020, which claims the benefit of U.S. Provisional Patent Application No. 62/836,574 having a filing date of Apr. 19, 2019, each of which is incorporated by reference in its entirety, including all appendices, as if fully set forth herein. This application also claims the benefit of U.S. Provisional Patent Application No. 63/550,965 having a filing date of Feb. 7, 2024 which is incorporated by reference in its entirety, including all appendices, as if fully set forth herein.

### BACKGROUND OF THE INVENTION

### Field of the Invention

The present invention relates generally to vehicle suspension systems, and more specifically to a bump stop for use in such systems.

### Description of Related Art

In the field of automotive suspension systems, shock absorbers and coil-over shocks serve a crucial role in vehicle stability, comfort, and performance by mitigating the impact of road irregularities. These components are designed to manage suspension travel and absorb shock loads during operation, thus ensuring the safe and smooth operation of vehicles. A critical aspect of these systems is the bump stop, which restricts excessive suspension movement and prevents potential damage to the shock absorbers. However, traditional bump stops have been observed to present several challenges that hinder optimal performance and reliability.

One issue identified with conventional bum stops is their susceptibility to debris intrusion. During vehicle operation, especially in off-road conditions, debris can frequently enter the shock housing, potentially leading to seal damage and fluid leakage. Such incidents may compromise shock absorber efficacy, requiring more frequent maintenance and replacements which can be both labor-intensive and costly. Traditional designs often lack effective mechanisms to prevent debris accumulation, resulting in reduced shock absorber lifespan and performance.

Another shortcoming noted with existing bump stop designs is their inability to accommodate varied suspension travel requirements. This is particularly critical for vehicles with diverse applications, such as off-road vehicles, where a one-size-fits-all solution is often inadequate. The inability to tailor bump stops to specific vehicle requirements often leads to suboptimal shock performance, as the fixed dimensions may either limit suspension travel or fail to protect against bottom-out impacts effectively. Additionally, the rigidity inherent in many conventional bump materials can contribute to impact harshness, rather than attenuating it.

What is needed is a bump stop that enhances debris management and provides customizable fit options while improving the durability and functionality of suspension systems. Such a solution would effectively reduce impact harshness, ensure consistent performance across varied applications, and offer a reliable mechanism for debris exclusion. Incorporating advanced materials and design features, this improved bump stop would address the limitations of traditional systems, thus extending shock absorber longevity and contributing to enhanced vehicle ride quality and stability.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.
U.S. Pat. No. 5,398,907—Hanger for Vehicle Exhaust Systems and the Like issued Mar. 21, 1995,
U.S. Pat. No. 5,868,384—Composite Elastomeric Spring issued Feb. 9, 1999,
U.S. Pat. No. 6,328,294—Elastomeric Spring System issued Dec. 11, 2001,
U.S. Pat. No. 8.733,746—Vehicular Suspension Enhancement issued May 27, 2014,
U.S. Pat. No. 9,656,627—Hood Bumpers to Absorb Loading issued May 23, 2017, and
U.S. Pat. No. 9,931,921—Soft Front Cockpit Cover issued Apr. 3, 2018, and

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a bump stop system designed for use in vehicle suspension systems featuring shock absorbers.

It is an object of the invention to provide a rubber bump stop that effectively deadens an stops a vehicle's suspension up-travel prior to providing the ultimate stopping function.

It is another object of the invention to provide a rubber bump stop with enhanced dampening capabilities compared to conventional OEM bump stops through customized physical size.

It is another object of the invention to provide a multi-layer rubber bump stop in a monolithic casting.

It is another object of the invention to provide a rubber bump stop that incorporates multiple types of elastomeric rubber components with different durometer values to achieve optimal dampening characteristics.

It is another object of the invention to provide a rubber bump stop that can be adapted for use in any make or model of vehicle while maintaining its performance characteristics.

It is another object of the invention to provide a rubber bump stop that can effectively be used in industrial applications, such as vibration pads, beyond its primary automotive use.

It is another object of the invention to provide a rubber bump stop that allows for predictable and predetermined object travel stopping in various applications.

It is another object of the invention to provide a rubber bump stop with superior dampening capabilities through the use of four different durometer rubber components.

It is another object of the invention to provide a rubber bump stop that incorporates a cast-in-place metal washer for enhanced durability and mounting capabilities.

It is another object of the invention to provide a rubber bump stop that can be securely mounted using bolts and medium-grade thread locker while maintaining its dampening properties.

It is another object of the invention to provide a rubber bump stop with carefully calibrated volume percentages of different durometer rubbers to achieve optimal performance characteristics.

It is another object of the invention to provide a rubber bump stop that offers a progressive dampening effect through the strategic layering of different durometer rubber components.

It is another object of the invention to provide a rubber bump stop that can be manufactured with either two, three, or four rubber components while maintaining effective dampening capabilities.

It is another object of the invention to provide a rubber bump stop that improves vehicle handling and comfort through superior suspension dampening characteristics.

The above and other objects may be achieved using devices involving a bump stop system designed for use in vehicle suspension systems featuring shock absorbers. The system incorporates a truncated dome strike pad positioned around the shock shaft, configured to impede further compression by contacting the shock can's outer periphery. This design serves to prevent debris intrusion and preserve the integrity of the shock seal.

In yet another aspect, the bump stop system includes a splined core with channels running parallel to the central shaft, which facilitates a self-cleaning mechanism by allowing debris to pass away from the shock shaft.

One object of the invention is to facilitate progressive dampening within the suspension system. To this end, the bump stop system may be constructed from a proprietary multi-durometer rubber. This composition includes a majority portion with a durometer ranging from about 60 to 80, and a minority portion ranging from about 20 to 60. A base portion with a durometer of about 80 or greater is integrated to provide this dampening effect.

In an embodiment, the bump stop system is provided with a flanged base, ensuring secure attachment atop the shock assembly. This flanged configuration accommodates various diameters of shock shafts, promoting versatility and adaptability within different suspension systems.

A method of installing the bump stop involves removal of the shock's top hat and coil cup, followed by centering and pressing the bump stop onto the shock shaft. The method includes securing and aligning the assembly by employing a flange. Additionally, a variant of the bump stop with a vertical split is available, permitting installation without the necessity of shock removal, and is secured using supplementary hardware.

In yet another embodiment, the bump stop may incorporate at least one groove extending from the well wall into the bump stop body. These grooves can be configured as multiple equally spaced grooves around the well wall to facilitate specific fit and performance requirements. Moreover, a friction fit may be employed to hold the bump stop body in place, ensuring stability during operation.

The bump stop system also allows for integration with various elastomeric mixtures, potentially serving as a spring assist within the suspension system. The method of provision includes arranging layered elastomeric mixtures designed to enhance the spring rate, providing control over shock up travel, and ensuring that diverse application requirements are met within vehicle suspension systems.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a multi-durometer bump stop with three different durometer volumes.

FIG. 2 depicts a bump stop according to some embodiments of the present invention.

FIG. 3a provides a close up overhead perspective view of the bump stop of FIG. 2.

FIG. 3b provides a close up below perspective view of the bump stop of FIG. 2.

FIG. 4 depicts a transparent view of the bump stop of FIG. 2.

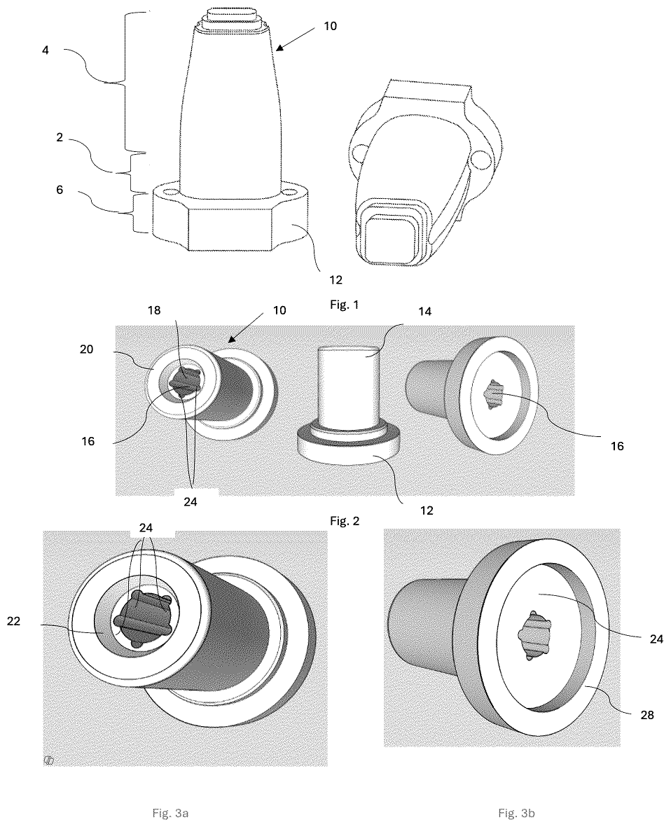

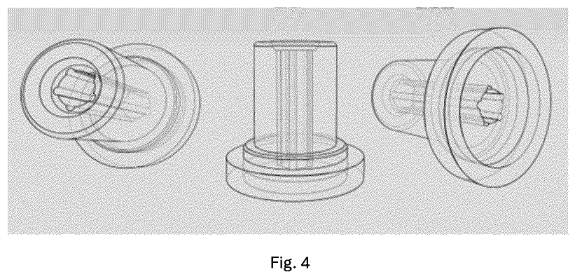

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The terms “including” and “such as” are not limiting and should be interpreted as “including, but not limited to,” and “such as, for example,” respectively. The term “about” when used to modify an amount means the amount plus or minus 20% of the amount. The full scope of the inventions is not limited to the examples that are described below.

In one application of the invention, a rubber bump stop for vehicles is provided using specific Durometer ranges and ratios of rubber that, when installed, effectively deadens the suspension's up-travel just prior to providing the ultimate stopping function. Durometers are based on the Shore hardness scale ASTM D2240 type A. Testing has revealed that an increase in bump stop size enhances the deadening effect compared to an OEM bump stop. Combinations of 2 to 4 types of rubber can effectively achieve a dampening effect. In some embodiments, the bump stop 10 is made from other materials such as micro-cellular foams, rubber, silicones, urethanes, thermal plastic elastomers, or any other suitable material.

The rubber bump stops may incorporate 4 types of elastomeric rubber, each determined by specific ratio percentages. The embodiment shown includes elastomeric rubbers with different durometers: 20 to less than 60, 60 to less than 75, greater than or equal to 75 to less than 85, and greater than or equal to 85. Metal hardware to connect the bump stop to a vehicle may be cast-in-place. For example, bolts and medium-grade thread locker, may be provided.

In one embodiment utilizing three rubber components, the composition comprises a first component of 5 to 20 volume percent with a durometer between 20 to less than 60, a second component of 60 to 85 volume percent with a durometer greater than or equal to 60 to less than 80, and a third component with a durometer greater than or equal to 80.

The composition ratios can be adjusted while maintaining consistent performance regardless of the physical shape or size of the bump stop. These principles are applicable in creating bump stops for any make or model vehicle, industrial vibration pads, or any application requiring bump stops that efficiently deaden impact and stop object travel in a predetermined, predictable fashion.

In implementations using two elastomeric rubber components, the composition preferably includes a first component comprising 10 to 20 volume percent with a durometer between 20 to less than 75, and a second component comprising 80 to 90 volume percent with a durometer greater than or equal to 75 to 90.

For three-component implementations, one composition comprises a first component of 5 to 10 volume percent with a durometer between 20 to less than 60, a second component of 65 to 75 volume percent with a durometer greater than or equal to 60 to less than 80, and a third component of 20 to 30 volume percent with a durometer greater than or equal to 80 to 90.

In another four-component implementation, the composition includes a first component comprising 5 to 15 volume percent with a durometer between 40 to less than 45, a second component comprising 60 to 80 volume percent with a durometer greater than or equal to 60 to less than 75, a third component comprising 15 to 20 volume percent with a durometer greater than or equal to 75 to less than 85, and a fourth component comprising 10 to 25 volume percent with a durometer greater than or equal to 85 to 90.

Referring to FIG. 1, one embodiment of a bump stop 10 includes elastomeric rubbers different durometers: a first component comprising 5 to 20 volume percent of an elastomeric rubber of the rubber bump stop and having a durometer between 20 to less than 60 (2), a second component comprising 60 to 85 volume percent of an elastomeric rubber of the rubber bump stop and having a durometer greater than or equal to 60 to less than 80 (4), and a third component of an elastomeric rubber of the rubber bump stop and having a durometer greater than or equal to 80 (6).

In an embodiment, the bump stop 10 may have a flared base 12 and an opposing top end 14. A hollow well 16 passes through the bump stop 10 having an interior well wall 18. The well 16 is configured to accommodate and surround the shaft of a shock. The circumference of the well wall 18 may conform closely to the circumference of the shock shaft to allow the well wall 18 to create a friction fit to the shock shaft. The circumference of the well wall 18 may also be significantly larger than the circumference of the shock shaft to allow dust and other materials to freely move between the shock shaft and the well wall.

The top end 14 has a strike surface 20 that contacts the shock can when the shock is compacted to the maximum desired distance. The bump stop 10 creates a physical barrier between the shock can and the end of the shock shaft to limit the travel of the shock. A top recess 22 around the well 16, creates a space over the seal on the shock can that prevents the bump stop from contacting the seal of the shock can and potentially damaging the seal or forcing dust or other debris through the seal. The top recess 22 can have a top recess wall that may be tapered or straight. The top recess reduces the risk of debris accumulating near the seal where the shock shaft enters the shock can. This would facilitate self-cleaning via gravitational forces during suspension travel, ensuring that debris naturally exits the void. The flared base 12 may also have a base recess 24 about the well 16 on the flared base 12. The base recess 24 is defined by a base rim 26 and a base recess wall 28.

In some embodiments, the well has one or more grooves 24 that run longitudinally along the well wall 18. These grooves 24 channel debris away from the shock shaft, potentially increasing the self-cleaning effect and further minimizing wear on shock components by creating a dynamic path for particles to circulate and be expelled during the operational movement of the bump stop.

In an embodiment relating to variable lengths and heights, the bump stop 10 may be available in incremental length variations, such as in steps of ⅛ inch, enabling precision fitting for a broader range of vehicles, particularly for those requiring meticulous suspension travel control in competitive off-road and racing situations.

In another embodiment, the flanged base design may incorporate a slotted configuration that permits adjustable positioning on the shock shaft, accommodating different vehicle geometries and enhancing the versatility of fitment across multiple shock absorber designs.

In operation, a bump stop 20 would be formed and provided to a user for installation on a vehicle suspension system. The bump stop may be formed by pouring a plurality of elastomeric mixtures into a mold and then allowing the bump stop to cure overnight at a room temperature above about 65 degrees Fahrenheit. In some instances, the cured bump stop 10 may be heated to about 150 degrees Fahrenheit and maintained at that temperature for at least about 4 hours.

The user would remove the shock's top hat and coil cup to expose the shock shaft, allowing the bump stop 10 to be centered and pressed onto the shaft. The flared base contacts the shock's coil spring and the coil cup and top hat are reassembled to align everything back into place. The bump stop 10 is held in place by sandwiching the flange of the bump stop between the coil spring and the coil spring retainer or cup.

In some embodiments, the bump stop slides over the shock shaft and is held in place via a friction fit by making the diameter of the well wall 18 slightly smaller than the diameter of the shock shaft diameter. The bump stop may have a large vertical split that would allow the bump stop to be mounted over the shock shaft without the need to remove the shock from the vehicle. The slit may be opened to allow the bump stop to be installed about the shock shaft an then the slit seam would be held closed with hardware. The hardware may be cast-in-place in the bump stop. The bump stop 10 may have ribs or grooves that allow for further compression and act as a crumple zone when the bump stop is compressed.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. A bump stop system for use in a vehicle suspension system having a shock that has a shock shaft, a shock can with a seal where a first end of the shock shaft enters into the shock can, and a shock hat on a second end of the shock shaft opposite to the first end, the system comprising:
a bump stop body having a flanged base, an opposing top end and a hollow well having a well wall configured to accommodate the shaft of the shock, the well running from the base end to the top end wherein the bump stop body has a flange configured to contact the shock hat to immobilize the bump stop body relative to the shock shaft; and
a concave strike surface on the top end allowing the top end to contact the shock can without contacting the seal.

2. The bump stop of claim 1, further comprising at least one groove extending from the well wall into the bump stop body.

3. The bump stop of claim 2 wherein the at least one groove is four grooves equally spaced about the well wall.

4. The bump stop of claim 1, wherein the bump stop body has a length ranging between about ⅜ inch to about 36 inches.

5. The bump stop of claim 1 wherein the bump stop body is held in place via a friction fit between the well wall and the shock shaft.

6. The bump stop of claim 1 wherein the bump stop body comprises an outer surface, the bump stop body further comprising a slit running from the well wall to the outer surface to allow the bump stop body to be opened to fit around the shock shaft and wherein the bump stop system further comprises hardware to hold the slit closed after placing the bump stop body around the shock shaft.

7. The bump stop of claim 6 wherein the hardware is cast in place.

8. A method of providing a bump stop for use in a vehicle suspension system having a shock that has a shock shaft, a shock can with a seal where a first end of the shock shaft enters into the shock can, and a shock hat or a shock eye on a second end of the shock shaft opposite to the first end, the method comprising the acts of:
forming a plurality of layered elastomeric mixtures into a bump stop body having a flanged base, an opposing top end and a hollow well having a well wall configured to accommodate the shaft of the shock, the well running from the base end to the top end wherein the bump stop body has a flange configured to contact the shock hat or shock eye to immobilize the bump stop body relative to the shock shaft;
forming a concave strike surface on the top end allowing the top end to contact the shock can without contacting the seal;
providing the bump stop body to a user and instructing the user to install the bump stop body such that the shock shaft resides in the hollow well.

9. The method of claim 8 wherein the third volume encompasses the flanged base of bump stop body.

10. The method of claim 8 wherein the plurality of elastomeric mixtures comprises a first volume having a durometer between about 60 and about 80, a second volume having a durometer between about 20 and about 60 and a third volume having a durometer between about 80 and about 90; and
wherein the second volume is configured to reside between the first volume and the third volume;

11. The method of claim 8 further comprising forming at least one groove extending from the well wall into the bump stop body.

12. The method of claim 11 wherein the at least one groove is four grooves equally spaced about the well wall.

13. The method of claim 8 wherein the bump stop body comprises an outer surface, the method further comprising:
forming a slit running from the well wall to the outer surface to allow the bump stop body to be opened to fit around the shock shaft;
providing hardware to hold the slit closed; and
instructing the user to open the bump stop body at the slit to fit around the shock shaft and then install the hardware to hold the slit closed after the bump stop body has been placed around the shock shaft.

14. The method of claim 13 wherein the hardware is cast in place.

15. The method of claim 8, wherein plurality of elastomeric mixtures is poured and then cured overnight at a room temperature above about 65 degrees Fahrenheit.

16. The method of claim 8 further comprising arranging the plurality of layered elastomeric mixtures to serve as a spring assist to the enhancing the spring rate of the suspension system.

17. The method of claim 8 further comprising providing a plurality of bump stop bodies to match specific applications and control shock up travel.

18. A bump stop system for use in a vehicle suspension system having a shock absorber, the shock absorber having a shock shaft that enters a shock can at a shock seal wherein said bump stop system comprises:
a bump stop having a top end with top surface and an extended strike surface positioned around the shock shaft, configured to impede further compression by contacting the shock can's outer periphery and not the shock seal.

19. The bump stop system of claim 18, further comprising a splined core with channels running parallel to the central shaft.

20. The bump stop system of claim 18, wherein the bump stop is provided with a flanged base for securing atop the shock, ensuring proper fit across different shock shaft diameters.
